(19) United States
(12) Patent Application Publication
(10) Pub. No.: US 2006/0028922 A1
(43) Pub. Date: Feb. 9, 2006

(54) System and method for displaying self-winding watches

(76) Inventor: Simon P. Wolf V, Malibu, CA (US)

Correspondence Address: FULWIDER PATTON, 6060 CENTER DRIVE, 10TH FLOOR, LOS ANGELES, CA, 90045, US

(21) Appl. No.: 10/912,972

(22) Filed: Aug. 6, 2004

(51) Int. Cl. G04B 37/00; G04B 47/00

(52) U.S. Cl. 368/316

(57) ABSTRACT

A system for displaying self-winding watches especially adapted for use in a retail store environment, includes a base and a plurality of watch-winders for holding self-winding watches, disposed on the base. Each of the watch-winders is selectively removable from the base, but is held in position on the base by tiles that are placed between the watch-winders to hold the watch-winders in a fixed relationship to one another. In one embodiment the base has only a single horizontal plane. In another embodiment, the base may be stepped to include a plurality of horizontal planes, arranged in a stair step-like fashion. The tiles are either fixable to the base by adhesive or some other suitable fastener, or are held in position upon the base by a raised edge running along the periphery of the base.

### FIELD OF THE INVENTION

This invention relates generally to a system and method for displaying wrist watches by a jeweler or vendor to the consumer public, and more particularly to a universal display system designed to display and simultaneously to keep wound a multiplicity of self-winding watches.

### BACKGROUND OF THE INVENTION

The retail watch trade is beset by a consumer public whose tastes often change. Some years ago, quartz digital watches significantly reduced consumer demand for the mechanical watches which had been the staple since wrist watches were invented. Today however, there is a resurgence of demand for mechanical watches, particularly for high-end self-winding mechanical watches. As will be described herein below, retail outlets face a number of issues arising from this resurgence in demand for self-winding watches.

Self-winding watches have been available for many years and are known to have mechanisms for keeping the watch wound while it is being worn by a user. The automatic winding mechanism of a self-winding watch typically includes a rotary pendulum or similar mechanism that is connected through a gear reduction system to a mainspring adapted to drive the watch. The pendulum pivots about a bearing and is generally capable of rotating a full 360 degrees. When the watch is worn, the random movements of the wearer cause the pendulum to oscillate back and forth, or to spin completely about its axis, thereby winding the mainspring. When completely wound, the mainspring will generally have sufficient energy to run the watch for up to about 12 to 48 hours, depending on the particular type of watch.

However, it will be appreciated that a vendor of self-winding watches is, naturally, not able to wear the watches while they are on display pending sale, so that the energy in their mainsprings will tend to completely dissipate while on display. Once the spring is unwound, a self-winding watch generally cannot, as can a manually wound watch, be fully rewound in a few seconds. For a vendor, it is highly undesirable to be obliged to show a customer a self-winding watch that has wound down, because this may create the impression that the watch is defective. However, the task of maintaining multiple watches wound and operating by a vendor is a major inconvenience, as it may include resetting the time, date, and numerous other functions, or “complications,” on an unwound watch each time the spring runs down.

In a typical retail setting, a watch vendor will place a plurality of watches of all kind in display counters in his or her store for the consuming public to view. The watches are often placed under a glass top on a pedestal or similar type of stand adapted to display the watches to best advantage. It will be appreciated, however, that if a self-winding watch is displayed in such fashion, it will quickly unwind, and the vendor will have difficulty in demonstrating the watch functions to a potential customer.

Various automatic watch-winders for winding multiple self-winding watches are currently available, but these systems typically are used by private collectors for private use. These systems generally include a plurality of watch-winding mechanisms mounted on a common vertical plane, in a permanently fixed and immovable relationship to one another. Each mechanism is designed to simulate in some fashion the motion of a watch being worn on a persons arm. For private collectors these devices are satisfactory because they allow the collector to stand on one side of the system and view his entire watch collection from one vantage point. However, these systems are not convenient for use by vendors in the retail trade. Generally they may be too large or too tall to be placed under a glass counter between the vendor and a customer where the watches may be simultaneously viewed by both. Moreover, they are not suitable for display in the retail trade because they suffer from the disadvantage that the individual watch-winders remain in a permanently fixed and immovable relationship to one another. Thus, when a watch is removed from such a display system, an empty winder is left to confront the viewer. This is undesirable in a retail store, which typically tries to maintain the impression in the mind of the consuming public that the stock on hand in the store reflects the maximum amount of product choice generally available in the market. Empty watch-winders would tend to imply that the choicest items have already been sold and that the consumer should look elsewhere for a wider choice of goods.

Thus, a need exists in the retail trade for an improved system for displaying to the consuming public a plurality of self-winding watches that is secure, that may be conveniently placed under a transparent display counter top to be viewed obliquely from above, and that may be periodically reconfigured each time a watch is removed to erase any indication of reduction in the stock of watches. It is believed that the present invention fulfills these and other needs.

### SUMMARY OF THE INVENTION

Briefly, and in general terms, the present invention provides a new and improved apparatus and method for displaying mechanical self-winding watches dynamically in a retail store environment while keeping the watches properly wound and functional over extended periods of time, and while reinforcing to prospective customers that the watches are of an automatic self-winding variety. The apparatus and method also offer the retailer the ability to customize the configuration of the display to suit his particular needs, to readily remove a single watch from the display for showing to a particular customer, and to eliminate the empty sales space after a watch has been sold.

In accordance with a preferred aspect of the invention, the apparatus includes a display platform, that when utilized rests in a substantially horizontal plane, with one or more watch-winders arranged on the platform. The platform has a raised edge along its perimeter, and is sized to hold a series of removable tiles and watch winders in a desired configuration. The watch winders have a base which conforms to the size and shape of the tiles, so that the watch winders and tiles can be interchanged on the display platform. When both the watch winders and the tiles are in place on the platform, the watch winders are held in a designated lateral position on the display platform.

The entire system is designed to be advantageously located securely in a display counter under a transparent countertop, so that it may be viewed from above. Each of the watch-winders is selectively removable from the base, so that the vendor may remove one watch-winder from the display at a time to show a customer, without having to remove the whole display from its place of safekeeping under the countertop. But at the same time each watch-winder is held in its lateral position on the base by one or more of the tiles. In this way, during the course of time, the watch winders retain their orderly arrangement in the display, held in position by the tiles in combination with a raised edge that runs along the perimeter of the base. Because the watch-winders are in constant motion in the process of rotating the watches to keep them wound, the display has an eye catching dynamic quality to the customers.

More specifically, and in a presently preferred embodiment, by way of example, and not necessarily by way of limitation, the present invention provides a system for displaying self-winding watches including a base having at least one upper planar surface, a plurality of separate watch-winders located upon the planar surface, with the watch-winders being substantially restrained against lateral movement in the plane of the surface. In another feature of the invention, the base may either have a single upper surface, or it may have a number of upper surfaces, separated from each other in a step-like configuration. In other aspects of the invention, each tile is made the substantially same size as the other tiles, each watch-winder has substantially the same shape as the other watch-winders, and the tiles are substantially the same size as a base portion of the winders. The system thus promotes a regularly laid out display in which the tiles and the winders entirely cover an upper surface of the base.

In another aspect of the invention directed to a method of displaying self-winding watches, the method includes providing a base having an upper planar surface, placing upon the planar surface at least one separate watch-winder, in which each watch-winder includes a self winding watch. Each watch-winder is laterally constrained on the base, but separately removable from the base. Another feature of the method includes placing sufficient tiles and watch-winders on the horizontal surfaces that the surface is entirely covered.

Other features and advantages of the invention will become apparent from the following detailed description, taken in conjunction with the accompanying drawings, which illustrate, by way of example, features of the invention.

### BRIEF DESCRIPTION OF THE DRAWINGS

FIG. 1 is a perspective view of a system for displaying watches, embodying features of the present invention.

FIG. 2 is a perspective view of a portion of the system shown in FIG. 1, specifically, the horizontal base with tile layout.

FIG. 3 is a perspective view of the system shown in FIG. 1, exemplifying, in partial breakaway view, how the system may be used in combination with a retail display counter.

FIG. 4 is a perspective view of an alternative embodiment of the present invention, exemplifying how the base may be stepped on different levels.

FIG. 5 is an enlarged perspective view of a watch-winder suitable for use in the display system of the present invention, showing the watch-supporting cuff removed from the drum.

### DETAILED DESCRIPTION OF THE PREFERRED EMBODIMENTS

As shown in the drawings, which are provided for purposes of exemplary illustration, a new and improved system and method for displaying self-winding watches embodying the principles and concepts of the present invention and generally designated by the reference number 30 will be described.

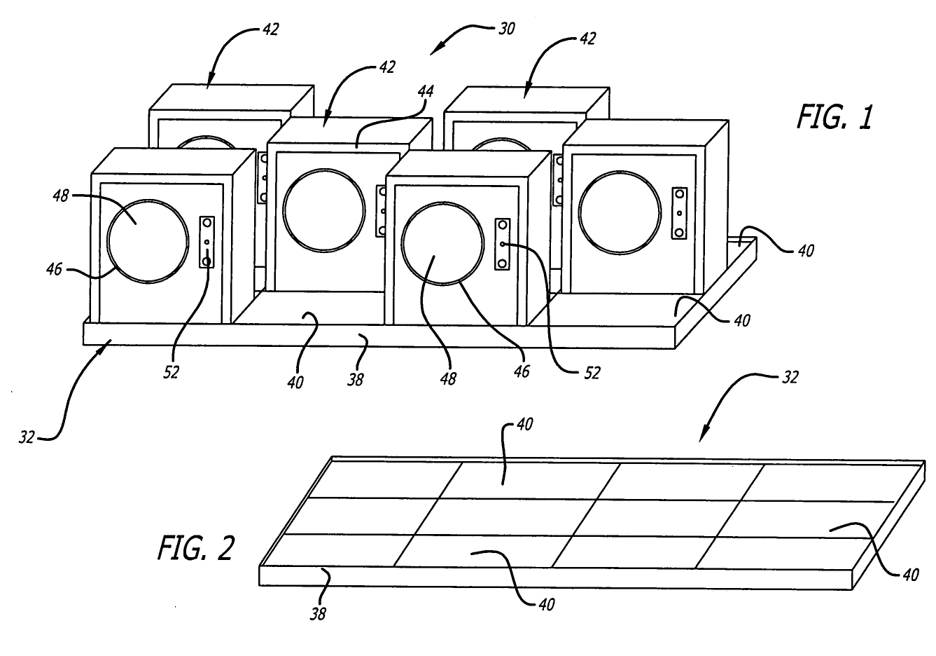

In a preferred embodiment as exemplified in FIGS. 1-3, the display system 30 includes a generally rectangular base 32 or platform configured, in a preferred embodiment, to be arranged generally horizontally and adapted to be slidably placed into a display counter 34 beneath a transparent countertop 36. While it is preferred that the base should be arranged in the display generally horizontally, it is also contemplated that the surface of the base may slope at an angle to the horizontal, up to about 30 degrees. Preferably, the base is made of wood or some other rigid material. As more clearly shown in FIG. 2, the base 32 has a raised edge 38 that extends around its perimeter, preferably extending about 1 cm above the top surface of the base.

As is seen in FIG. 2, a number of inset, removable tiles 40 are disposed along the top surface of the base 32. The tiles 40 can be provided in various sizes and shapes. However, in a preferred embodiment, the tiles are configured to be generally rectangular in shape, identical to each other, and sufficient in number to occupy the total upper surface area of the base 32 in a series of rows and columns. In the preferred embodiment, the tiles are about 1 cm thick, resulting in the top surface of the tiles being flush with the top of the raised edge 38. The tiles 40 are preferably made of ceramic or fine hardwood, but may also be made of a less expensive material such as cardboard covered in fabric.

When the system 30 is ready for use, as exemplified in FIG. 1, some of the tiles are removed, and the gaps created thereby are filled by placing a watch-winder 42 therein. Eventually a plurality of watch-winders 42 and a plurality of tiles 40 are arranged to entirely cover the surface of the base. In this regard, the size and shape of each tile is chosen to be the same as a bottom portion of the watch-winder 42, which, in the preferred embodiment, will be a rectangle of about 12 cm by 12 cm. The watch-winders 42 are relatively compact in size and may be placed on the base 32 in any configuration or pattern suitable to display watches mounted thereon to one viewing from above.

When the watch-winders 42 and tiles 40 are positioned accordingly, it will be apparent that the spatial relationship of the winders to each other is held relatively constant by the tiles, in conjunction with the surrounding raised edge 38, thus preventing any accidental horizontal sliding or movement of the winders along the surface of the base 32. This has the advantage of maintaining the display in its original orderly configuration which might otherwise become disordered as the base 32 is moved in and out of the display counter 34 or otherwise disturbed over the course of time.

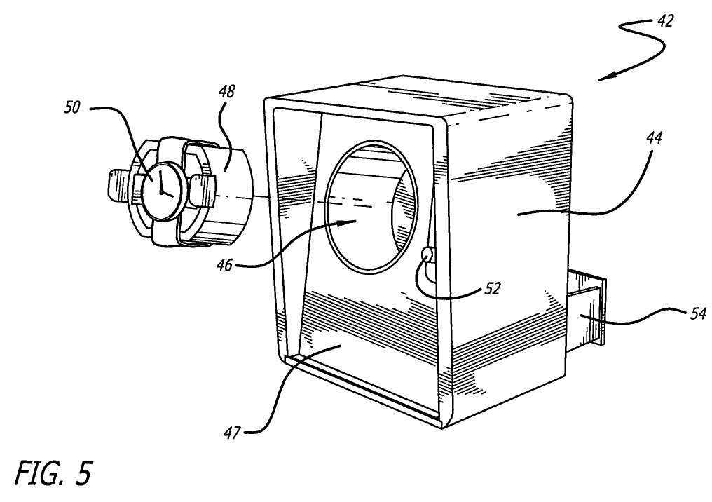

Preferably, as illustrated in FIG. 5, each watch-winder 42 includes a separate outer housing 44 that is approximately cubic in form, although other shapes or forms of housing are also contemplated by the present invention. A circular hollow drum or turntable 46, adapted to rotate on its axis, is mounted within the housing 44, preferably on an upright generally vertical surface 37, although it is also contemplated that the front face may slope at an angle less than perpendicular to the base. A cuff 48 removably inserted within the drum is adapted to hold a self-winding wrist watch 50 on the drum so that the face of the watch is visible from the front of the winder. When the drum rotates with the watch and cuff in place, the watch rotates within the plane of the watch face, to thereby wind the self-winding mechanism of the watch.

In a preferred embodiment, each watch-winder is powered by a small electrical motor and associated electronic control circuit located within the housing 44. The electric circuit may be adapted to wind the watch in a first direction, to pause, and then wind in a second direction with each rotation being performed for a predetermined number of cycles. Various modes of rotation, controlled by the circuit, also may be selected by setting a switch on a control panel 52 on the front face of the winder 42. In a preferred embodiment, four settings are provided, namely, off, clockwise rotation, anti-clockwise rotation, and reversing rotation—that is, clockwise followed by anti-clockwise rotation and so on repeating. Preferably, each winder in the display will be separately powered by its own battery power supply placed in a removable drawer 54 in the rear of the housing. A particularly suitable watch-winder 42 is illustrated and described in my co-pending U.S. application Ser. No. 10/845,463, filed May 12, 2004, the disclosure of which is incorporated herein by reference in its entirety.

It will be appreciated that maintaining the winders 42 in a constant spatial relationship with each other may additionally or alternatively be accomplished by means such as applying an adhesive strip or hook and loop system (e.g., Velcro®) to the upper surface of the base and the lower surface of the tiles, with or without the raised edge 38.

In a preferred embodiment, the winders 42 are arranged on the base 32 along a generally rectangular grid system. However, other layouts may also be used such as a diagonal grid system, circular, triangular, etc. or any combination thereof, customizable to the vendor's choice. It will be appreciated that the system of removable tiles enables a vendor to reconfigure the layout of the winders at will, thereby enabling him to customize the display to his own particular needs.

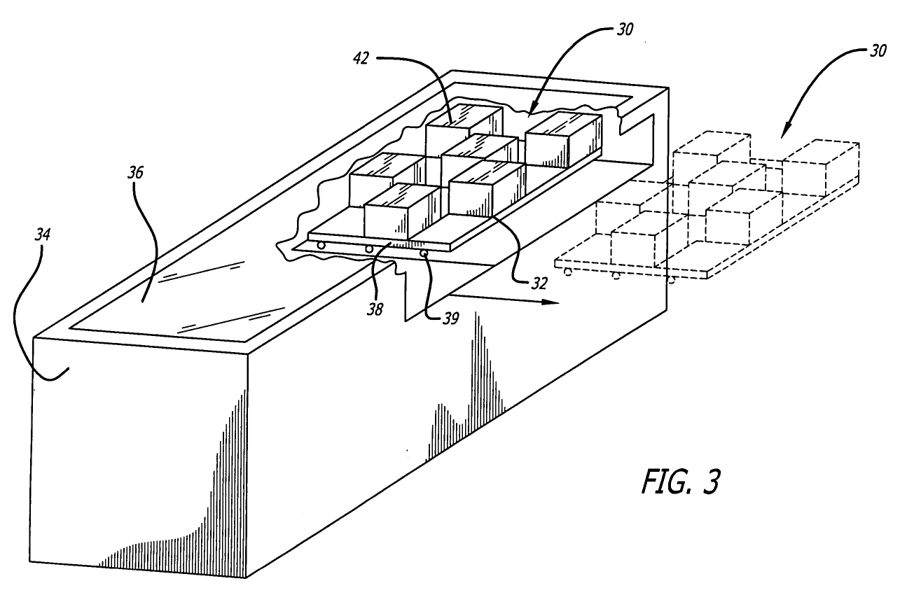

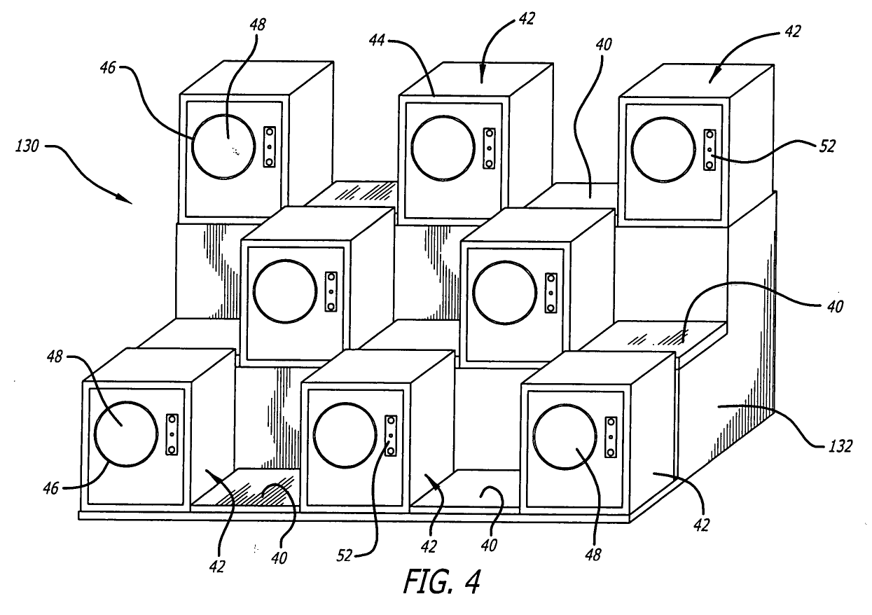

In use, the display system 30 may be slid onto a shelf in a display counter 34 with the assistance of rollers 39 or a friction slide, optionally attached to the base as exemplified in FIG. 3. The substantially horizontal configuration of the base allows the display to conveniently be viewed through a transparent countertop 36, while also allowing the counter to be locked for security.

FIG. 4 illustrates an alternative embodiment of the invention, generally designated by the reference number 130, in which the base 132 may be configured to have a series of steps, with the effect that the winders 42 resting thereon step upwards from the front to the back from the perspective of the viewer. This may provide more convenient viewing of the display in that winders to the rear are not obscured by winders in front, but the configuration requires a deeper drawer space in the display counter. It may be noted that the embodiment exemplified in FIG. 4 has three rows and five columns of tiles/winders, whereas the embodiment exemplified in FIG. 1 has three rows and four columns.

As in the previous embodiment, the tiles 40 may be left in position on the horizontal surface of the base between the winders 42 to maintain the desired ordered spacing of winders. In the embodiment exemplified in FIG. 4, a raised edge is not shown, but such may be added to secure the tiles against horizontal movement if adhesive or other type of connecting system is not selected to fix the tiles 40 to the base 32, or to hold the winders on the end of a row.

A vendor using either of the display systems 30, 130 can arrange the watch-winders 42 as desired on the base 32 by replacing one or more of the tiles 40 with a watch-winder as indicated above. Preferably, each watch-winder 42 will contain a watch so that no empty sales space is presented to the consumer. In addition, it is preferable that the winders should be activated, at least during normal store hours. Advantageously, the vendor is not obliged to remove the entire display system from the counter to show a particular watch to a customer. Rather, he need only remove only a single winder containing the watch of interest, because the winders are individually separable from the base and not connected to each other.

When a watch is sold, the watch and winder are removed, leaving a gap. A replacement tile may then be inserted into the gap. This has the effect of restoring the horizontal restraint which prevents the watch-winders from becoming disordered, while also leaving no indication to consumers that any watch has been removed from the stock of watches in the display. It will be appreciated that, if the vendor wishes to maintain symmetry of the display, or to otherwise change the display pattern, the winders and tiles may be rearranged as desired after a winder has been removed. It will be further appreciated that the size of the replacement tiles may be varied so that, when a winder has been removed, half size tiles may be placed at the ends of the row (in combination with rearranging the winder positions), to maintain symmetry of the display.

The same procedure may be followed effectively in reverse when the vendor wishes to restock the display system 30. Tiles 40 may be removed from the base 32 and the gaps thereby created may be filled with watch-winders holding a mounted watch, to a configuration that suits the vendor's purpose.

In yet a further embodiment, it will be appreciated that the watch-winders of the display systems 30, 132 may be constrained against movement on the base by immovably fixing them to the base, by for example by using an epoxy adhesive or similar. In this case, it will be understood that the watch-winders may not be separately removed from the base, but the display systems will still retain the advantage of being an eye catching dynamic display that may be secured under a countertop.

It will be appreciated that each of the various display systems 30, 130 of the invention is attractive to customers, who will immediately be drawn to the part of the retail store which displays the self-winding mechanical watches. Because the system is literally “dynamic,” it will attract the attention of customers by its movement, distinguishing itself from the stationary displays of the other types of watches. Furthermore, the system maintains the watches in a wound state so that the vendor may explain to a customer the intricacies of the watch confident that it will appropriately display the correct time, date, lunar phase, and other functions the watch may have.

While several particular forms of the invention have been illustrated and described, it will also be apparent to those of ordinary skill that various modifications can be made without departing from the spirit and scope of the invention.

We claim:

1. A system for displaying self-winding watches comprising:
a base having at least one upper planar surface;
a plurality of separate watch-winders located upon the planar surface;
wherein the watch-winders are substantially restrained against movement in the plane of the surface, but are individually removable from the base.

2. The system of claim 1, wherein each watch-winder is separately powered and separately controllable.

3. The system of claim 1, wherein each watch-winder includes a removable cuff for holding a wrist watch within a rotatable drum.

4. The system of claim 1, further comprising at least one tile resting on the base and positioned to act as a restraint against horizontal movement of at least one watch-winder.

5. The system of claim 4, wherein a space exists between at least two of the watch-winders, and the at least one tile is positioned within the space.

6. The system of claim 4, wherein a space exists between at least one watch-winder and the edge of the base, and the at least one tile is positioned between the watch-winder and the edge of the base.

7. The system of claim 4, wherein the upper surface of the base is entirely covered with watch-winders and tiles.

8. The system of claim 4, wherein each tile is the same size as the other tiles, each watch-winder has the same shape as the other watch-winders, and the tiles are the same size as a base portion of the winders.

9. The system of claim 1, wherein the upper surface of the base lies within a single substantially horizontal plane.

10. The system of claim 1, wherein the base has a stepped configuration with more than one upper planar surface.

11. The system of claim 1, further comprising a raised edge extending upwards from the periphery of the base.

12. The system of claim 1, further comprising a hook and loop fastening system for removably attaching the tiles to the base.

13. The system of claim 1, further comprising a display counter, wherein the counter is configured to slidably receive the base, and the base is configured to slidably enter the counter.

14. The system of claim 13, further comprising rollers attached to the base for slidably positioning the base in the counter.

15. The system of claim 13, wherein the counter has a transparent surface, through which the base and the watch-winders may be viewed.

16. A method of displaying self-winding watches, comprising:
providing a base having at least one upper planar surface;
placing upon said at least one upper planar surface at least one separate watch-winder;
securing the watch-winder to be held in lateral position on the base, but separately removable from the base.

17. The method of claim 16, wherein at least one tile is placed on the base and positioned adjacent the at least one watch-winder.

18. The method of claim 17, wherein sufficient tiles and watch-winders are placed on the at least one planar surface that the surface is entirely covered.

19. The method of claim 17, wherein the at least one tile is removably attached to the base.

20. The method of claim 19, wherein the at least one tile is attached to the base with a hook and loop system.

21. The method of claim 17 wherein each tile is the same size as the other tiles, each watch-winder has the same shape as the other watch-winders, and the tiles are the same size as a base portion of the winders.

22. The method of claim 16, wherein a raised edge extends upwards from the periphery of the base, and at least one watch-winder is placed adjacent the raised edge.

23. The method of claim 16, wherein a raised edge extends upwards from the periphery of the base, and at least one tile is placed adjacent the raised edge.

24. The method of claim 16, further comprising:
removing a watch-winder from the base; and
placing a tile on the base in the position previously occupied by the winder.

25. The method of claim 11, where the tile has substantially the same size and shape as the bottom portion of the watch winder.

26. A kit for assembling a display for self-winding watches comprising:
a base having at least one planar surface;
a plurality of watch-winders suitable for placing on the base;
a plurality of tiles configured to be placed on the base and to cooperate with the base so that the tiles are substantially restrained against movement in the plane of the base, but are removable from the base.

27. The kit of claim 26, wherein the base includes only one planar surface.

28. The kit of claim 26, wherein each watch-winder is separately powered and separately controllable.

29. The kit of claim 26, wherein each watch-winder includes a removable cuff for holding a wrist watch within a rotatable drum.

30. The kit of claim 26, wherein each tile is the same size as the other tiles, each watch-winder has the same shape as the other watch-winders, and the tiles are the same size as a base portion of the winders.

31. The kit of claim 26, wherein the base is stepped to include a plurality of parallel planar surfaces.

32. The kit of claim 26, wherein the tiles and the base are adapted to detachably adhere to each other.

33. The kit of claim 26, wherein a raised edge extends upwards from the periphery of the base, the raised edge being configured to restrain movement of a tile resting on the planar surface of the base beyond the perimeter of the base.

34. The kit of claim 26, further including a display counter adapted to slidably receive the base.

35. The kit of claim 34, wherein rollers are disposed on the base for slidably placing the base within the display counter.

36. The kit of claim 34 wherein the counter has a transparent side.
